(19) United States
(12) Patent Application Publication
(10) Pub. No.: US 2003/0081352 A1
(43) Pub. Date: May 1, 2003

(54) Flow gate for slider level fly height or dynamic control

(76) Inventors: Ram M. Rao, Shoreview, MN (US); Zine-Eddine Boutaghou, Vadnais Heights, MN (US); Deborah S. Schnur, Minneapolis, MN (US); Michael S. Bowers, Bloomington, MN (US)

Correspondence Address: Deirdre Megley Kvale, Westman, Champlin & Kelly, International Centre, Suite 1600, 900 Second Avenue South, Minneapolis, MN, 55402-3319, US

(21) Appl. No.: 10/117,146

(22) Filed: Apr. 5, 2002

Related U.S. Application Data
(60) Provisional application No. 60/335,784, filed on Oct. 30, 2001.

(51) Int. Cl. G11B 5/60

(52) U.S. Cl. 360/235.4

(57) ABSTRACT

A slider having slider level fly height or dynamic control. The slider level fly height control includes a flow gate on a slider body interposed in a flow path along an air bearing surface of the slider body. The flow gate is operable to regulate flow along the air bearing surface to provide dynamic or fly height control for the slider.

### CROSS-REFERENCE TO RELATED APPLICATION

This application claims priority from U.S. Provisional Application 60/335,784 filed on Oct. 30, 2001 and entitled METHOD TO ACHIEVE AAB FLY HEIGHT CONTROL.

### FIELD OF THE INVENTION

The present invention relates generally to data storage devices, and more particularly but not by limitation to slider or head level fly height or dynamic control features.

### BACKGROUND OF THE INVENTION

Data storage devices store digital information on a rotating disc. Heads are supported relative to the disc surface to read data from or write data to the disc. For proximity or near proximity recording, transducer elements are carried on an air bearing slider to form a data head to read data from or write data to the disc. The slider is flexibly coupled to a suspension assembly to pitch and roll relative to the disc surface. The suspension assembly supplies a load force to the slider at a load point about which the slider pitches and rolls.

Suspension assemblies are supported by actuator arms of an actuator block to move the slider or head relative to selected data tracks on the disc surface. For operation, rotation of the disc creates an air flow along the air bearing of the slider to create a hydrodynamic lifting force. The hydrodynamic lifting force is countered by the load force supplied by the suspension assembly so that the slider or head flies above the disc surface at a fly height defined in part by the hydrodynamic lifting force of the air bearing and the load force supplied by the suspension assembly. Variations in fly height parameters can affect read/write operations. Embodiments of the present invention provide solutions to these and other problems, and offer other advantages over the prior art.

### SUMMARY OF THE INVENTION

The present invention relates to slider level fly height or dynamic control. The slider level fly height control includes a flow gate on a slider body interposed in a flow path along an air bearing surface of the slider body. The flow gate is operable to regulate flow along the air bearing surface to provide dynamic or fly height control for the slider. Other features and benefits that characterize embodiments of the present invention will be apparent upon reading the following detailed description and review of the associated drawings.

### BRIEF DESCRIPTION OF THE DRAWINGS

FIG. 1 is a perspective illustration of a data storage device.

FIG. 2 is a diagrammatic view of a head coupled to a suspension arm.

FIG. 3 is a diagrammatic illustration of a flow gate for slider level control.

FIGS. 4-6 diagrammatically illustrate flow gates operable by a flow gate actuator.

FIG. 7 diagrammatically illustrates a flow gate interposed in a flow path for pitch control.

FIG. 8 diagrammatically illustrates flow gates interposed in a flow path for roll control.

FIG. 9 diagrammatically illustrates a plurality of flow gates for slider or head level control.

FIGS. 10-11 diagrammatically illustrate a flow gate structure including a gate portion formed of a material having an energizable dimension change.

FIGS. 12-13 illustrate an electrostatic flow gate structure for flow control.

FIGS. 14-18 illustrate an embodiment of an air bearing structure including a flow gate.

FIG. 19 illustrates an alternate air bearing structure including a flow gate.

FIG. 20 graphically illustrates pitch and fly height parameters for operation of the flow gate of FIG. 19.

FIG. 21 illustrates an air bearing structure including opposed flow gates.

FIG. 22 graphically illustrates roll parameters for operation of the flow gate structure illustrated in FIG. 21.

FIGS. 23-24 illustrate an air bearing structure having a plurality of flow gates.

FIG. 25 illustrates an electrostatic flow gate embodiment for the plurality of flow gates of FIG. 23.

FIG. 26 illustrates a wafer level flow gate fabrication embodiment.

FIG. 27 is a flow chart of a fabrication embodiment of a slider having a flow gate

### DETAILED DESCRIPTION OF ILLUSTRATIVE EMBODIMENTS

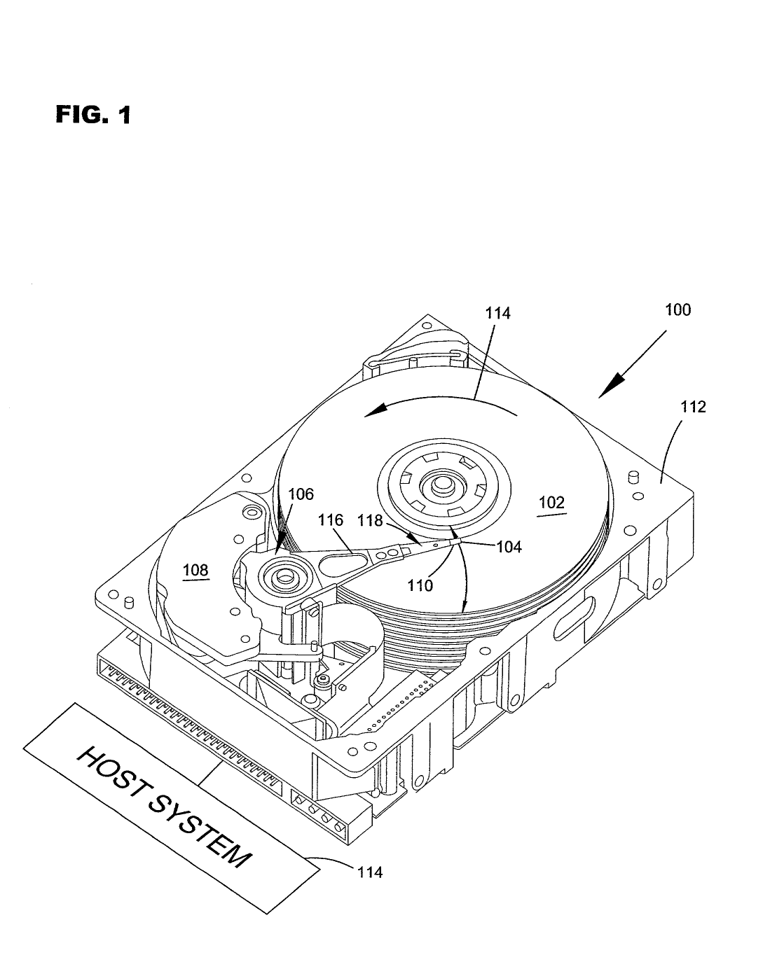

FIG. 1 illustrates an embodiment of a disc drive 100 in which digital information is stored on a plurality of discs 102 (or single disc 102). Heads 104 are positioned relative to the disc surface to read data from or write data to the disc 102. In the embodiment shown, heads 104 are coupled to an actuator assembly 106 which is powered by a voice coil motor 108 to position heads relative to selected data tracks on the disc surface. Heads 104 include an air bearing slider 110 having transducer elements carried thereby for read-write operation. Transducer elements include, for example, inductive, magnetoresistive or magneto-optical transducer elements. Components of the disc drive are supported relative to a base chassis 112 of the disc drive.

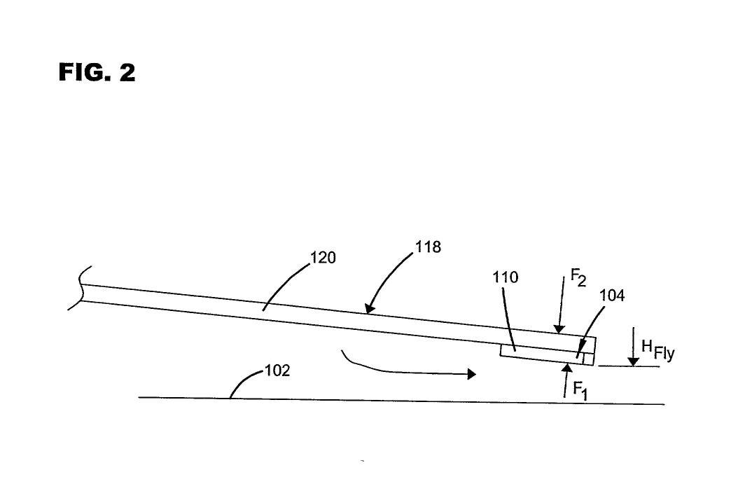

Discs are supported for rotation as illustrated by arrow 114 by a spindle motor (not shown) for operation. The head or slider 110 is coupled to actuator arms 116 of the actuator assembly 106 through a suspension assembly 118. Rotation of the discs 102 creates an air flow along an air bearing surface of the slider 110 to provide a hydrodynamic lifting force F₁, to the slider 110 in a first direction as illustrated in FIG. 2. The suspension assembly 118 includes a suspension arm 120 which supplies a pre-load force F₂ to the slider 110 in a second opposite direction which counters the hydrodynamic lifting force F₁. Negative pressure air bearing sliders 110 also include a negative pressure suction force which counters the lifting force F₁. For operation, the equilibrium of the pre-load force F₂, the hydrodynamic lifting force F₁ and suction force for a negative pressure air bearing define in part a fly height H_{fly} of the slider 110 for read/write operations. Areal disc drive density is increasing and thus lower fly heights H_{fly} are desired for optimizing read-write clarity and resolution. The lower fly height of the slider 110 reduces acceptable fly height variations or fly height sigma.

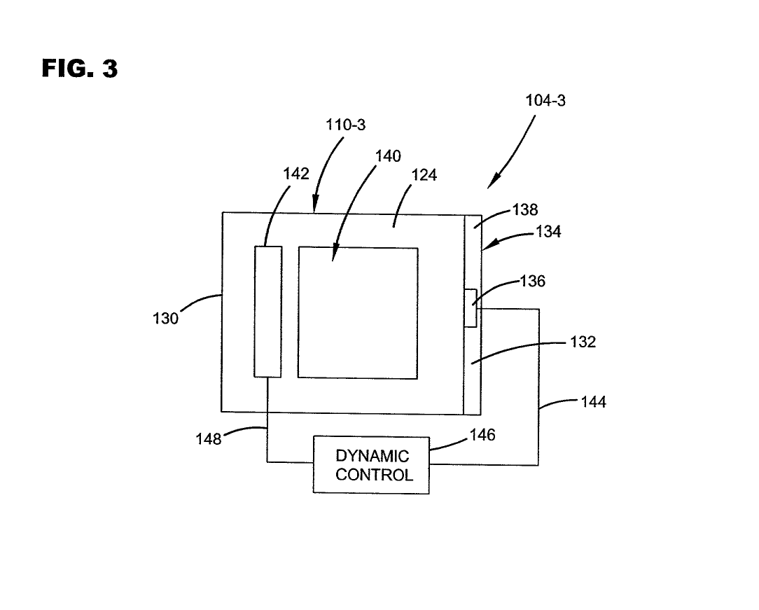

The present invention relates to a slider level fly height or dynamic control device. The slider level control device provides fly height or dynamic control for desired operation. FIG. 3 schematically illustrates an embodiment of the slider level control device of the present invention. As shown, slider 110-3 includes a slider body 124 having a leading edge 130 and a trailing edge 132. As schematically illustrated the trailing edge 132 of the slider body 124 includes a transducer 134 including transducer element(s) 136 embedded in a substrate 138, such as Alumina, to form the head for read/write operations. The slider body 124 includes an air bearing surface 140 between the leading and trailing edges 130, 132 of the slider body 124. As previously described, rotation of the disc creates an air flow between the leading and trailing edges 130, 132 of the slider 110-3. Pressurization of the air flow along the air bearing surface 140 of the slider provides a hydrodynamic lifting force F₁ or pressure force (e.g. negative pressure force) to the slider. The magnitude of the hydrodynamic lifting force F₁ or pressure force is defined in part by the surface area or design of the air bearing surface 140.

In the illustrated embodiment, the slider 110-3 includes a flow gate 142 (illustrated schematically) to control or meter air flow to the air bearing surface 140 of the slider 110-3. The flow gate 142 is operable to adjust air flow along the air bearing surface 140. The flow gate 142 regulates air flow to adjust a pressure profile of the air bearing surface 140 to adjust the hydrodynamic lifting force F₁ or pressure force to the slider. In the illustrated embodiment, operation of the flow gate 142 is controlled via feedback from the transducer as illustrated by line 144 to control or adjust dynamic operation of the slider as illustrated by block 146 based upon inter alia read/write clarity or resolution. Thus, feedback from the transducer 144 is used to control operation of the flow gate 142 as illustrated by line 148 to adjust the fly height or dynamic parameters of the slider.

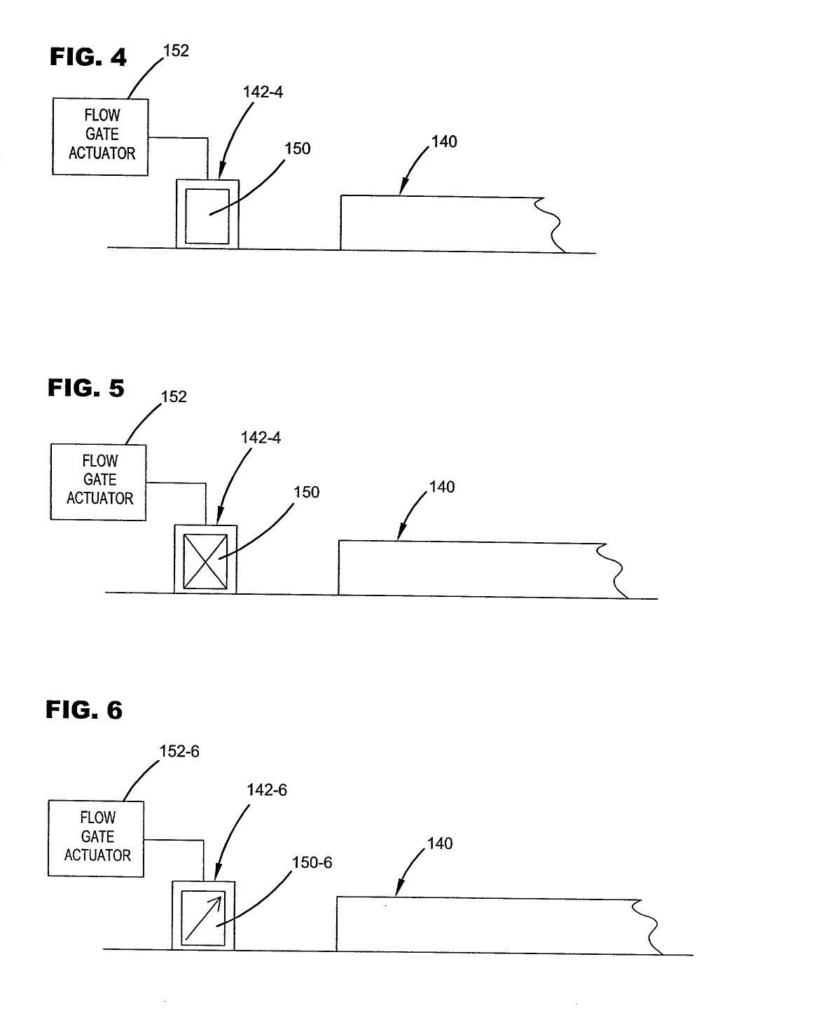

As illustrated schematically in FIGS. 4-5, flow gate 142-4 includes a flow passage opening 150 operable between an opened position shown in FIG. 4 and a closed position shown in FIG. 5 by a flow gate actuator 152. In the opened position, air flows through the flow passage opening 150 to pressurize the air bearing surface 140 and in the closed position illustrated in FIG. 5, air flow through the flow passage 150 is restricted as schematically illustrated. As previously described, operation of the flow gate actuator 152 can be controlled based upon feedback from the transducer.

In an embodiment illustrated in FIG. 6, flow gate 142-6 has a variable flow passage opening 150-6 to control air flow to the air bearing surface 140 for desired fly height or dynamic control. Operation of the variable flow passage opening 150-6 is controlled by flow gate actuator 152-6 to incrementally adjust an area or dimension of the flow passage opening 150-6 between an opened position and a closed position for fly height or dynamic control.

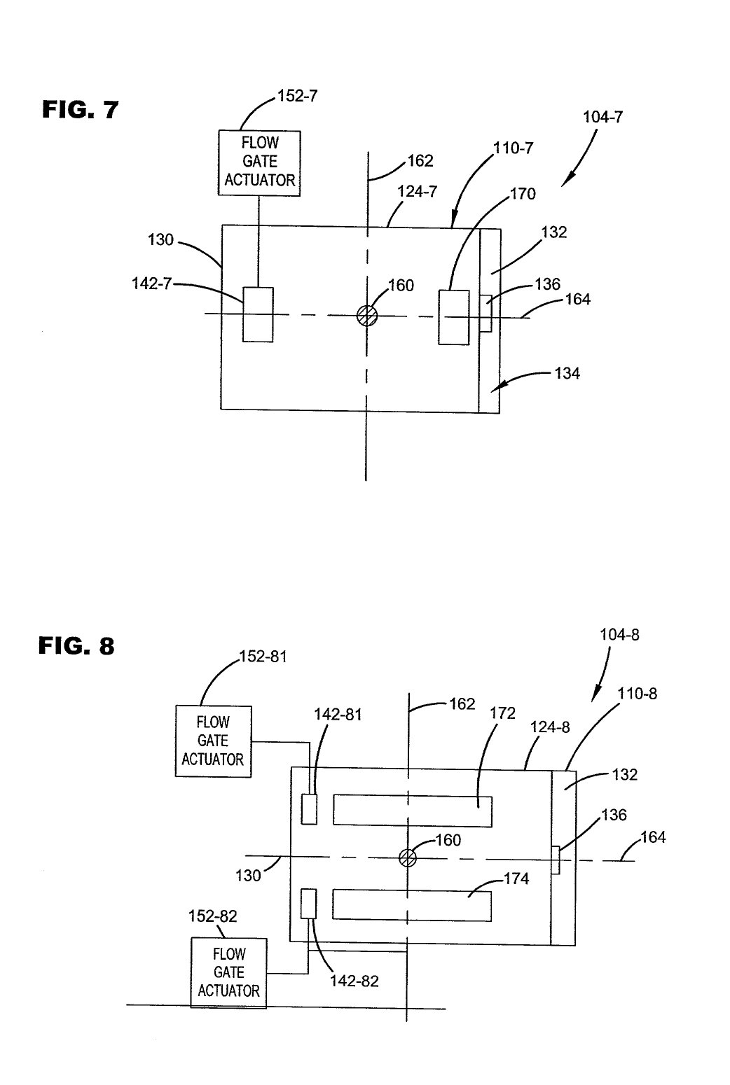

The load arm 120 of the suspension assembly 118 supplies a load force to slider 110-7 as illustrated in FIG. 7 at a load point 160 about which the slider pitches and rolls. In particular, the load point 160 defines a pitch axis 162 and a roll axis 164 about which the slider pitches and rolls. Typically, the slider flies at a pitch angle with the trailing edge 132 of the slider (and transducer 134) flying closer to the disc surface than the leading edge 130 of the slider. Adjustments in the pitch angle of the slider can adjust fly height of the transducer 134 relative to the disc surface. FIG. 7 schematically illustrates a flow gate 142-7 operable to adjust pitch angle of the slider. In the particular embodiment shown, the air bearing surface includes a raised trailing edge bearing surface 170 (or center pad). The raised trailing edge bearing surface 170 is located on a trailing edge portion of the slider body relative to the pitch axis 162 which defines a boundary between a leading edge portion and a trailing edge portion of the slider body 124-7. As shown flow gate 142-7 is interposed in an air flow path to the trailing edge bearing surface 170 (or center pad) to regulate air flow to the trailing edge bearing surface 170.

The flow gate 142-7 is coupled to actuator 152-7. Actuator 152-7 operates the flow gate 142-7 to adjust air flow to the trailing edge bearing surface 170 to raise or lower the trailing edge portion of the slider relative to the pitch axis 162 to adjust the pitch angle of the slider. The pitch angle of the slider can be adjusted to adjust the fly height of the transducer 134 relative to the disc surface for read/write operations. Although FIG. 7 illustrates a particular control embodiment, pitch can be adjusted using flow control to the air bearing surface relative to the pitch axis 162 and leading and or trailing portions of the slider.

FIG. 8 illustrates flow gates 142-81 , 142-82 to control air flow to raised bearing surfaces 172, 174 on opposed sides of the roll axis 164 to provide roll control. In particular, in the embodiment illustrated in FIG. 8, slider 110-8 includes side rails 172, 174 on opposed sides of the roll axis 164, and the flow gates 142-81, 142-82 are adjusted by flow gate actuators 152-81, 152-82 to adjust air flow to rails 172, 174 to adjust the roll attitude of the slider 110-8. Although FIG. 8 illustrate multiple flow gates to provide roll control, application is not limited to multiple gates and a single gate or alternate control embodiment can be employed to provide flow control to the air bearing surface relative to the roll axis 164 of the slider.

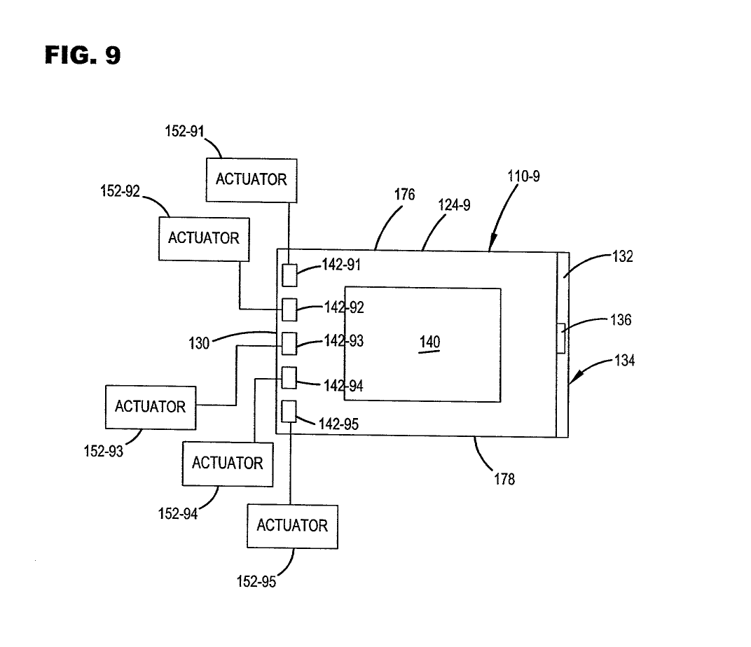

FIG. 9 illustrates an alternate slider level control embodiment including a plurality of flow gates 142-91 through 142-95. The flow gates 142-91 through 142-95 are spaced between opposed sides 176, 178 of the slider body 124-9 to provide air flow control to the air bearing surface 140 of the slider illustrated schematically. Flow gates 142-91 through 142-95 are operably coupled to flow gate actuators 152-91 through 152-95 to selectively control the flow gates for dynamic slider level control. Although a particular number of flow gates is shown, application of the present invention is not limited to a particular number of flow gates.

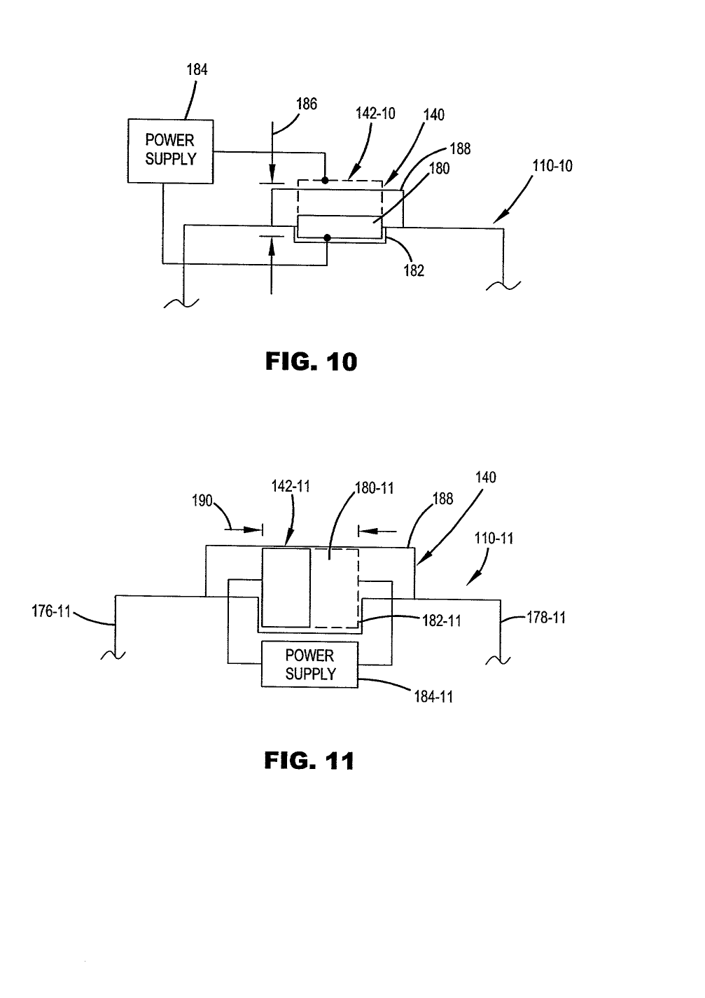

FIGS. 10-11 illustrate an embodiment of a flow gate structure 142-10 including an actuatable gate portion 180 movable relative to a body portion 182. The actuatable gate portion 180 is movable relative to the body portion 182 by the flow gate actuator to open and close a flow passage or area in the flow path to the air bearing surface 140 of the slider. In the illustrated embodiment, the actuatable gate portion 180 is formed of a material having an energizable dimension change such as a piezoelectric material or a shape memory material (such as Nitinol-a nickel-titanium alloy). The energizable material is coupled to a power source 184 for actuation.

In the embodiment illustrated in FIG. 10, a height elevation 186 of the gate portion 180 is adjusted between a recessed position and a raised position relative to an elevation of raised bearing surfaces 188 of the air bearing surface 140 of the slider. In the embodiment illustrated in FIG. 11, the actuator gate portion 180-11 includes an adjustable width dimension 190 relative to opposed sides 176-11, 178-11 of the slider. Similar to the embodiment illustrated in FIG. 10, gate portion 180-11 having the adjustable width dimension 190 is formed of a material having an energizable dimension change. The width dimension 190 of the gate portion 180-11 is adjusted via power source 184-11 to provide adjustable flow control to the air bearing surface 140 of the slider.

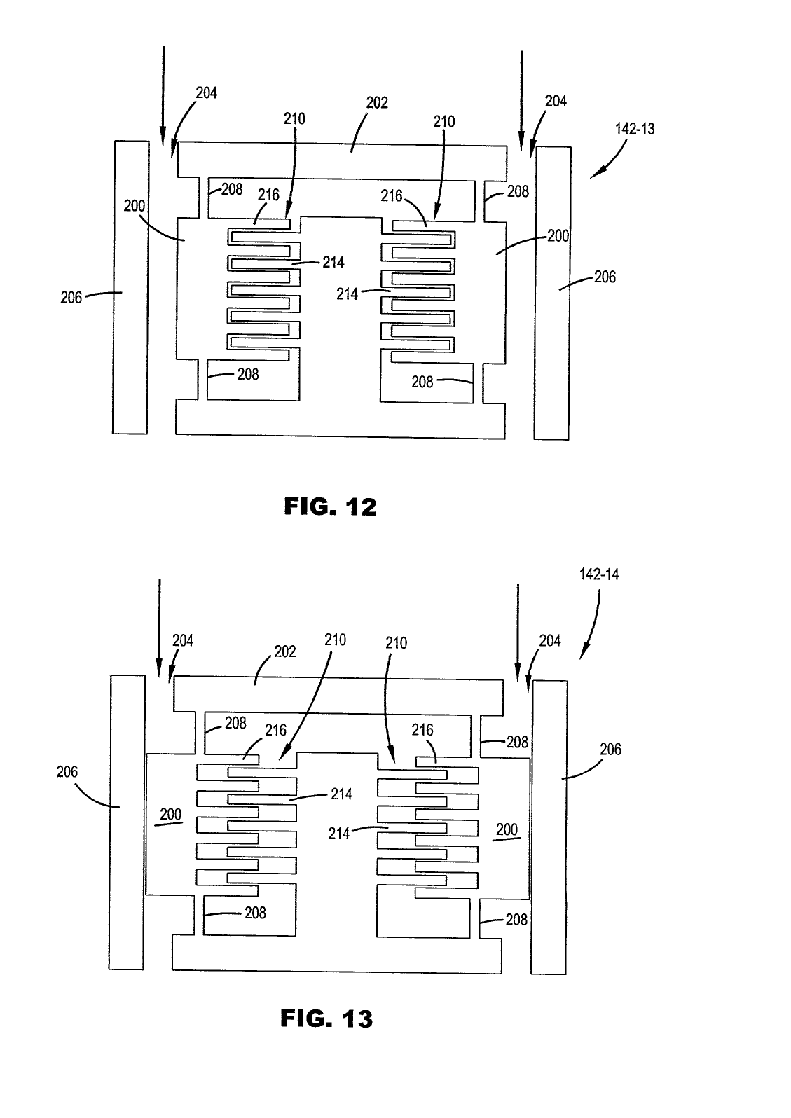

FIGS. 12-13 illustrate an alternate flow gate structure having an electrostatic actuator coupled to a power source. In particular, as schematically shown, the flow gate structure includes adjustable gate portion(s) 200 floatable supported relative to a body portion 202 to move between an opened position shown in FIG. 12 to a closed position shown in FIG. 13. The gate portion(s) 200 are moved between the opened position and the closed position to open and close a flow passage 204 formed between the gate portion 200 and a flow passage structure 206. In the illustrated embodiment, the gate portion 200 is floatable coupled to the body portion 202 by a flexible spring portion 208 and is actuated between the opened and closed positions by an electrostatic comb 210.

The electrostatic actuator or comb 210 includes a static electrode comb 214 on the body portion 202 and a floating electrode comb 216 coupled to the actuatable gate portion(s) 200. The electrode combs 214, 216 include a plurality of spaced electrodes which are energized to move the gate portion(s) 200 between the opened position and the closed position to adjust the flow passage area or dimension for desired flow control. In one embodiment, the gate portion 200 is normally opened and the electrode combs 214, 216 are energized to move the gate portion 200 to the closed position to restrict the flow passage 204. Alternatively, the gate portion 200 can be normally closed and the electrostatic actuator can be energized to move the gate portion(s) 200 to the opened position to open the flow passages 204. The electrostatic flow gate is fabricated on the slider using micro-electro-mechanical systems (MEMS) fabrication techniques. Although FIGS. 12-13 illustrate a particular electrostatic passage or gate control structure, application is not limited to the particular structure or orientation shown.

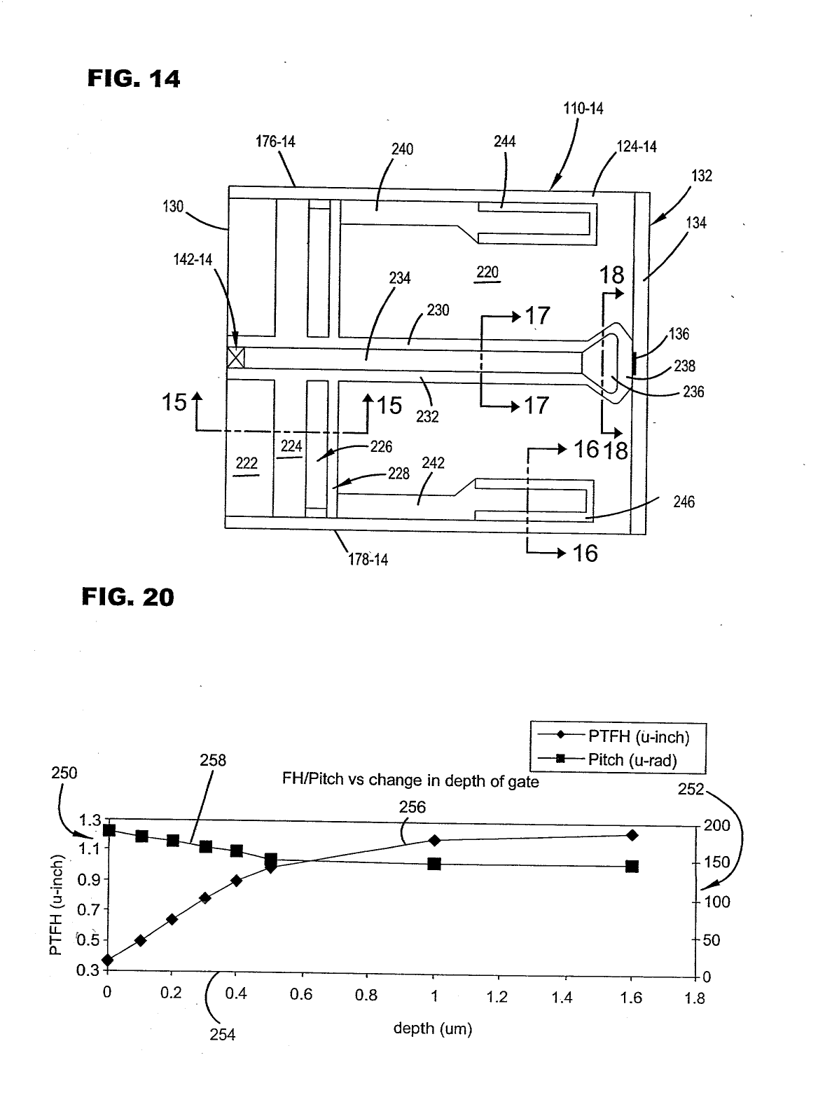

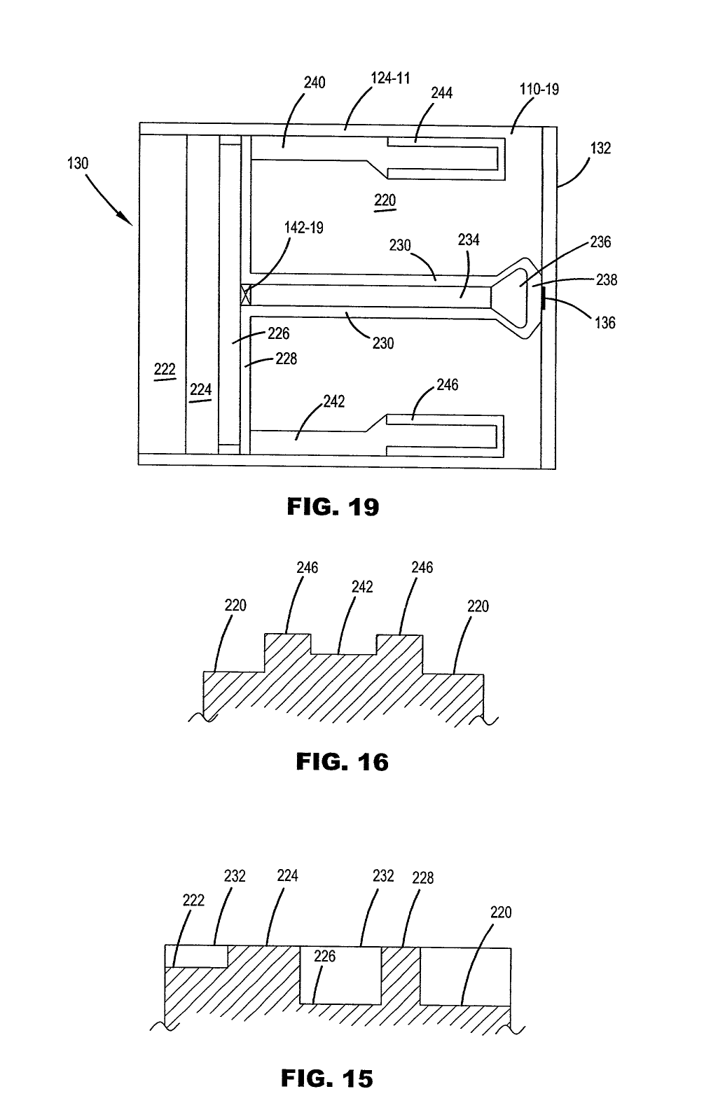

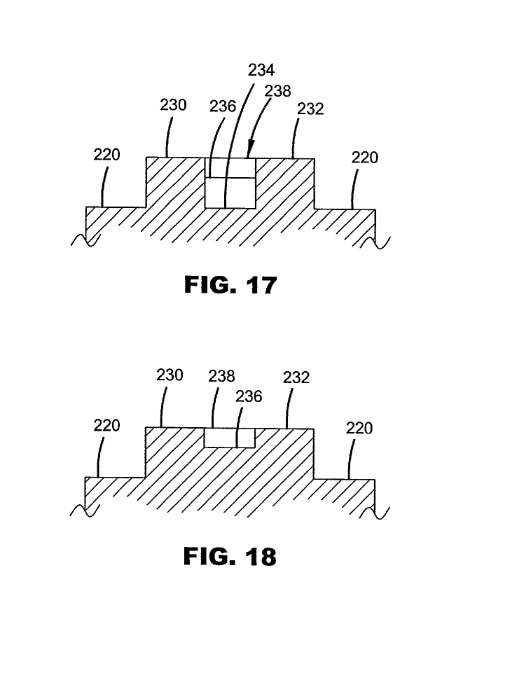

FIGS. 14-18 illustrate an embodiment of a slider 110-14 having a flow gate 142-14 proximate to a leading edge 130 of the slider. As shown, the air bearing surface of the slider 110-14 includes a cavity portion 220 and raised bearing surfaces including a leading edge bearing portion having a stepped surface 222, a raised bearing portion 224, a cavity step 226 and a traverse rail portion 228 interposed in a flow path between the leading edge 130 and trailing edge 132 of the slider.

In the illustrated embodiment, the air bearing includes a center bearing portion including longitudinal rails 230, 232 and a longitudinal cavity 234. A trailing edge portion of the slider includes center step 236 and raised portion 238. The bearing includes side portions including stepped bearing surfaces 240, 242 and raised bearing surfaces 244, 246. In the illustrated embodiment, the leading edge flow gate 142-14 is centered between opposed sides 176-14, 17814 of the slider and interposed in a flow path along longitudinal cavity 234 to center step 236 and raised portion 238 to provide slider level fly height or pitch control.

In an alternate embodiment illustrated in FIG. 19 having a similar air bearing structure, where like numbers are used to refer to like parts of FIGS. 14-18, flow gate 142-19 is interposed in an air flow path at an intermediate position between the leading and trailing edges 130, 132 of the slider 110-19. As shown in FIG. 19, slider 110-21 includes a center cavity 234 which is spaced from the leading edge 130 of the slider body 124-11, and opened to transverse cavity 226. Flow gate is fabricated at a leading end of cavity 234 at an intersection between cavity 226 and cavity 234 to provide flow control to the stepped and raised bearing surfaces 236 and 238.

FIG. 20 graphically illustrates fly height and pitch (in μ radians) parameters as illustrated by axis 250, 252 relative to operation of flow gate 142-19 having an energizable depth dimension change as illustrated by axis 254. As shown by line 256, the fly height of the head or transducer (e.g. pole tip fly height for an inductive transducer (PTFH)) increases as the recessed depth dimension of the gate portion increases relative to a reference surface of the raised rails 230, 232, 236, 238 (to open the gate portion) to provide increased air flow along the flow path.

Alternatively, for a lower recessed depth dimension of the gate portion relative to the reference surfaces (to close the gate portion), the fly height decreases since reduced air flow is provided along cavity 234. Pitch angle in μ radians decreases as illustrated by line 258 as the recessed depth of the gate portion increases or the gate portion opens to provide increased air flow to the bearing surfaces. Less air flow provided by a lower recessed depth dimension of the gate portion increases the pitch angle of the head or slider as illustrated by line 258.

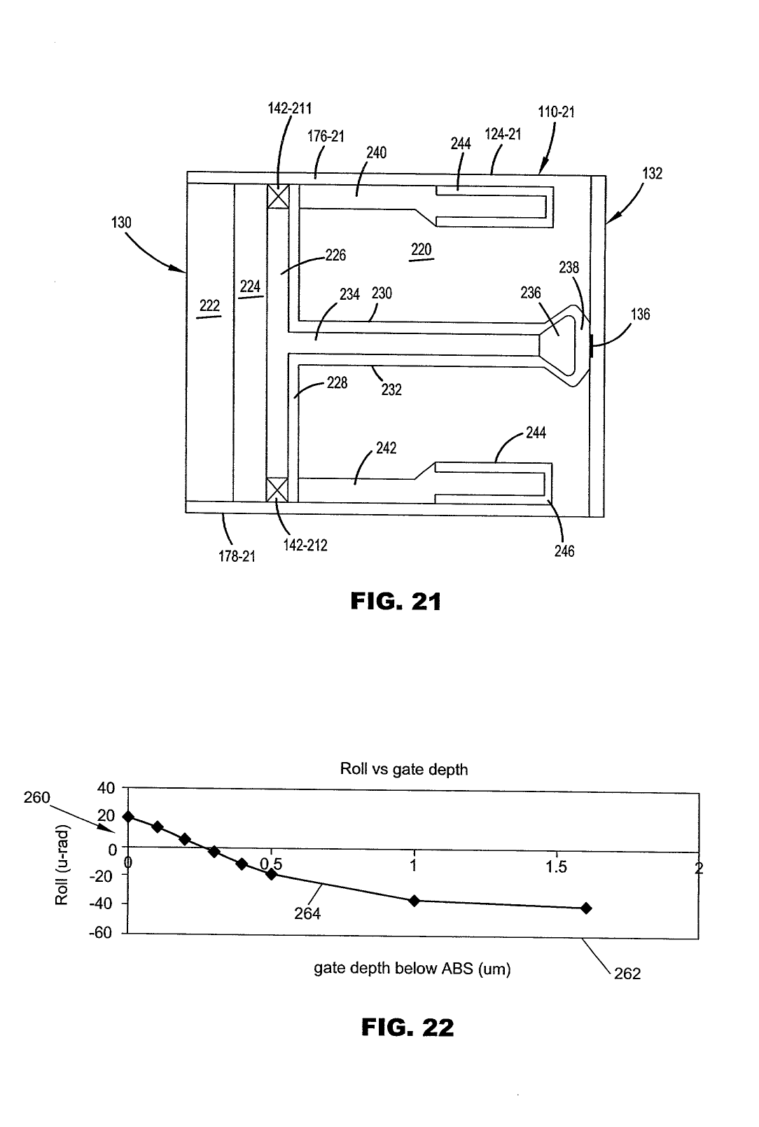

FIGS. 21-22 illustrate opposed flow gates operable to provide dynamic roll control. In particular, FIG. 21 illustrates a similar air bearing structure as illustrated in FIG. 19 where like numbers are used to refer to like parts. As shown in FIG. 21, the slider 110-21 includes opposed flow gates 142-211, 142-212 interposed in a flow path to cavities 226, 234. In particular, flow gates 142-211, 142-212 are positioned on opposed sides 176-21, 178-21 of the slider body to control flow to opposed inlets on opposed sides of cavity 226. FIG. 22 illustrates roll (It radians) 260 as a function of gate depth 262. As illustrated by line 264, as the recessed gate depth for either flow gate 142-211, 142-212 increases to open the flow gate to increase flow to cavity 226, the roll angle shifts as illustrated by line 264 to adjust the roll angle of the slider.

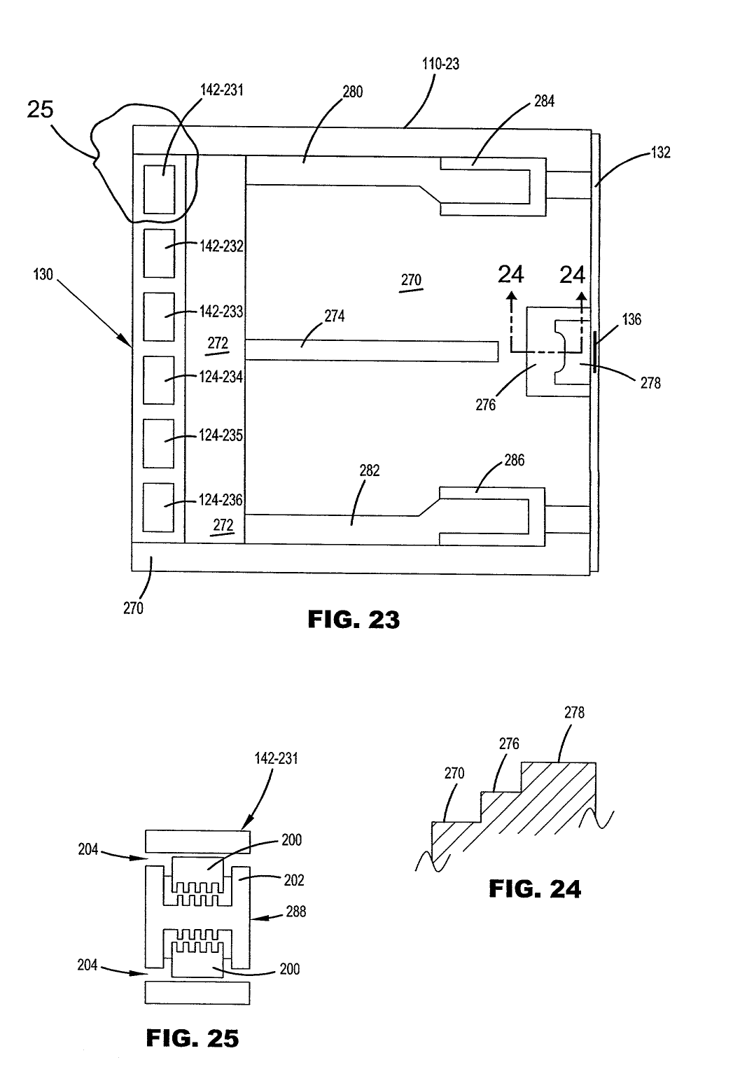

FIGS. 23-24 illustrate an embodiment of a slider 110-23 including a plurality of spaced flow gates 142-231 through 142-236 to control flow to the air bearing surfaces of the slider 110-23. In particular, the air bearing structure of slider 110-23 includes a cavity portion 270, a raised leading edge surface 272, a stepped center rail 274, a center pad including a stepped surface 276 and a raised surface 278, and opposed stepped rails, including stepped surfaces 280, 282 and raised surfaces 284, 286. Flow gates are fabricated at the leading edge as shown and in one embodiment illustrated in FIG. 25, flow gates include an electrostatic comb structure 288, as previously described, to control air flow to the bearing surface of the slider 110-23.

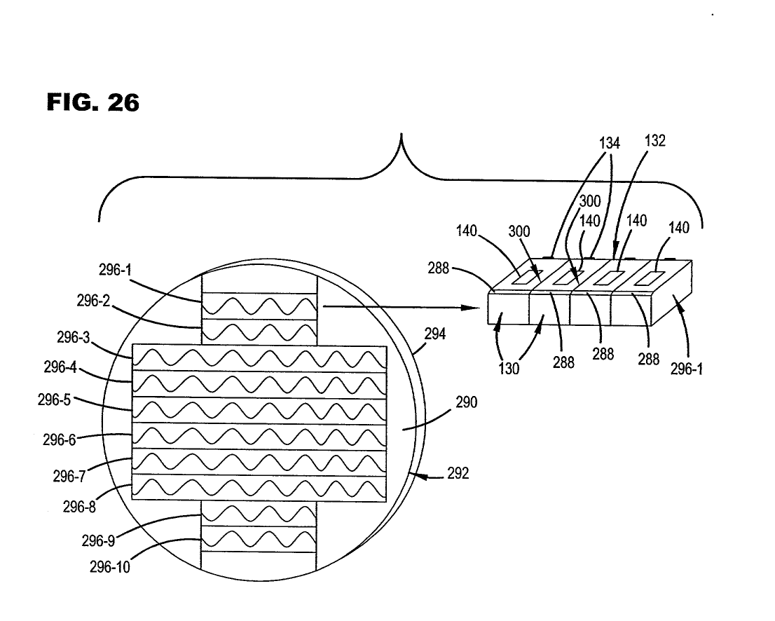

As illustrated in FIG. 26, the electrostatic comb structure 288 can be fabricated at the wafer level using MEMS fabrication techniques. In particular, the comb structure 288 is fabricated on a surface 290 of a wafer 292 to form an array of comb structures 288 along a leading edge portion of the slider. Transducers (not shown) are fabricated on a second opposed surface 294 of the wafer 292 to form the transducer 134 at a trailing edge of the slider. Bars 296-1 are cut from the wafer 292 and a plurality of air bearing surfaces 140 are formed along the bars i.e. bar 296-1 as illustrated and sliders 300 are cut from the bar 296 having a comb structure 288 formed on a leading portion of the slider. Alternate flow gate structures can be fabricated at the wafer level or bar level after bars 296 are cut from the wafer 292.

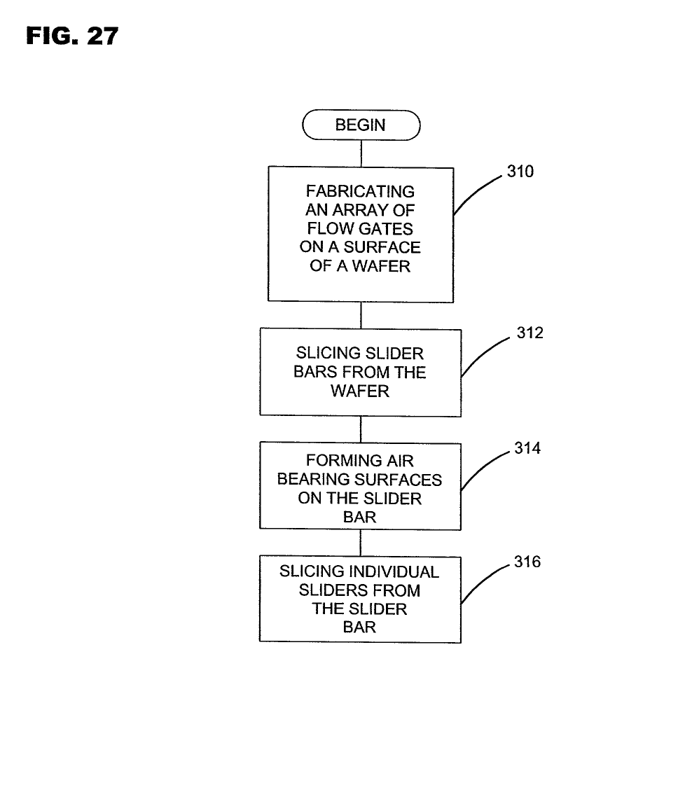

FIG. 27 is a flow chart illustrating a wafer level fabrication embodiment. As illustrated by block 310, an array of flow gates 142 are fabricated on a surface 290 of the wafer 292. A slider bar 296 is sliced from the wafer 292 as illustrated by block 312. A plurality of air bearing surfaces 140 are formed along the slider bar 296. The air bearing surfaces 140 are fabricated using known masking and etching fabrication processes as illustrated by block 314. Following fabrication of the air bearing surfaces 140 individual sliders 300 are sliced from the slider bar 296 as illustrated by block 316.

A slider 110 having slider level fly height or dynamic control. The slider level fly height control includes a flow gate 142 on a slider body 124 of the slider interposed in a flow path along the air bearing surface 140 of the slider body 124. The flow gate 142 is operable to regulate air flow along the air bearing surface to provide dynamic or fly height control for the slider 110.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements (or particular design of the air bearing surface) may vary without departing from the scope and spirit of the present invention and other element may vary depending upon the particular application while maintaining substantially the same functionality without departing from the scope and spirit of the present invention. In addition, although the preferred embodiment described herein is directed to a magnetic data storage device, it will be appreciated by those skilled in the art that the teachings of the present invention can be applied to optical or other devices, without departing from the scope and spirit of the present invention.

What is claimed is:

1. A slider comprising:
a slider body including a leading edge, a trailing edge and opposed sides and including an air bearing surface having at least one raised bearing surface and at least one recessed bearing surface; and
at least one flow gate on the slider body interposed in a flow path along the air bearing surface of the slider body.

2. The slider of claim 1 including a plurality of flow gates on the slider body.

3. The slider of claim 2 wherein the plurality of flow gates are spaced along the leading edge of the slider body.

4. The slider of claim 1 wherein the at least one flow gate is positioned between opposed sides of the slider body.

5. The slider of claim 2 wherein the plurality of flow gates includes a first flow gate proximate to one of the opposed sides of the slider body and a second flow gate proximate to another of the opposed sides of the slider body.

6. The slider of claim 1 wherein the flow gate includes a gate portion operable by a flow gate actuator to increase or decrease a flow passage area of the at least one flow gate to regulate flow to the air bearing surface of the slider.

7. The slider of claim 6 wherein operation of the flow gate actuator is controlled via feedback from transducer elements on the slider body to regulate flow to the air bearing surface of the slider.

8. The slider of claim 6 wherein the flow gate actuator is an electrostatic actuator.

9. The slider of claim 8 wherein the electrostatic actuator includes an static electrode comb on a body portion of the flow gate and a floating electrode comb on the gate portion of the flow gate and the gate portion is movably coupled to the body portion.

10. The slider of claim 9 wherein the gate portion is movably coupled to the body portion of the flow gate by a flexible spring portion.

11. The slider of claim 6 wherein the gate portion is formed of a material having an energizable dimension change and the gate portion is coupled to a power source to form the flow gate actuator to regulate flow to the air bearing surface of the slider.

12. The slider of claim 11 wherein the material having the energizable dimension change includes a piezoelectric or shape memory material.

13. The slider of claim 1 wherein the flow gate is interposed in the flow path to the air bearing surface of the slider body to adjust pitch, roll or fly height parameters of the slider.

14. A slider comprising:
a slider body including a leading edge, a trailing edge and opposed sides and including an air bearing surface having at least one raised bearing surface and at least one recessed bearing surface; and
means for controlling air flow along the air bearing surface of the slider body.

15. The slider of claim 14 wherein the means for controlling air flow along the air bearing surface includes at least one flow gate selectively operable to regulate flow to the air bearing surface of the slider body based upon operating feedback.

16. The slider of claim 14 wherein the means for controlling air flow along the air bearing surface includes an electrostatic flow gate operably coupled to a power source and energizable to regulate flow to the air bearing surface of the slider.

17. The slider of claim 14 wherein the means for controlling air flow along the air bearing surface includes a flow gate having a gate portion formed of a material having an energizable dimension change operably coupled to a power source and energizable to regulate flow to the air bearing surface of the slider.

18. The slider of claim 14 wherein the means for controlling air flow along the air bearing surface includes at least one flow gate on a leading edge portion of the slider body of the slider.

19. A disc drive comprising:
a disc having a disc surface rotationally coupled to a drive chassis and operable to rotate relative to the drive chassis for operation; and
a head including a slider carrying a transducer element to read data from or write data to the disc surface, the slider including a slider body having a leading edge, a trailing edge and opposed sides and including an air bearing surface having at least one raised bearing surface and at least one recessed bearing surface and at least one flow gate on the slider body interposed in a flow path along the air bearing surface of the slider body.

20. A method of fabricating a slider comprising steps of:
fabricating an array of flow gates on a wafer;
slicing a slider bar from the wafer; and
forming air bearing surfaces on the slider bar and slicing individual sliders from the slider bar.

21. The method of claim 20 wherein the step of fabricating the array of flow gates on the wafer includes:
fabricating an electrostatic comb structure on the wafer to form the array of flow gates.

22. The method of claim 18 and wherein the flow gates are fabricated on a first surface of the wafer and comprising the step of:
fabricating an array of transducers on a second surface of the wafer.
